(19) United States
(12) Patent Application Publication
(10) Pub. No.: US 2003/0043046 A1
(43) Pub. Date: Mar. 6, 2003

(54) Vibration sensing satellite call-out unit

(76) Inventors: Stephen F. Watwood, Oak Creek, CO (US); Bruce R. Bacon, Golden, CO (US); Dale R. Hedman, Littleton, CO (US)

Correspondence Address: DORR CARSON SLOAN & BIRNEY, PC, 3010 EAST 6TH AVENUE, DENVER, CO, 80206

(21) Appl. No.: 10/231,981

(22) Filed: Aug. 30, 2002

Related U.S. Application Data
(60) Provisional application No. 60/316,858, filed on Aug. 31, 2001.

(51) Int. Cl. G08B 21/00

(52) U.S. Cl. 340/683; 340/531

(57) ABSTRACT

The present invention is a remote device that is field adjustable and easily installed with user defined sensitivity for detecting vibration of a piece of equipment. The device is self-contained to detect vibration and compare it to a reference value. Upon a defined condition being met, the unit sends an alarm via satellite of the alarm condition event to a desired location.

### RELATED APPLICATIONS

The applicants claim priority of Provisional Patent Application Serial No. 60/316,858 entitled “Vibration Sensing Satellite Call-Out Unit”. Stephen F. Watwood, Bruce R. Bacon and Dale R. Hedman inventors.

### BACKGROUND OF THE INVENTION

1. Field of the Invention

The present invention relates to remote monitoring of equipment to detect if they are operating. Vibration is used as an indication of the equipment running. The condition is determined and a notification is sent in the event the equipment stops or acts improperly. The utility is in the ease of installation, set up, adjustment and signal and alarm dissemination and receipt.

2. Discussion of the Background

Monitoring of the working condition of equipment, such as natural gas compressors, is important to the continued proper operation of many installations. Usually the compressor is located in a factory or near other installations. In these circumstances, monitoring of the equipment is readily done by the operational personnel on site. However, in circumstances of remote installations, there may be no on site personnel to monitor the equipment or the on site inspection only occurs at scheduled intervals. In these circumstances the fact that the equipment is not running, or not operating properly, may not be detected for some extended time, hours, days or weeks, until someone happens or is scheduled to go to the site or there is a telltale change in the output of the installation that creates an impact at a location related to the installation.

This delay can result in extensive down time, and sometimes extensive property damage to equipment, the environment or lost commodities and resources.

In those circumstances where remote real-time monitoring of equipment is essential, extensive provisions must be made. These may and often include, having electrical power delivered to the remote site as traditional call-out systems require significant power sources. Also if power fails, there is often no communication available. Either wireless or landline communication links need to be established and independent of power at the site to communicate the operational conditions of the equipment. Finally there must be a detection device to sense the operational conditions that is crucial. But these all require specialized installation and maintenance.

In very remote locations the power and communication links can pose large obstacles. In harsh environments the power, signal and sensing devices can pose a large burden on maintenance and reliability and requires nontrivial installation and maintenance by trained and qualified personnel, which translate to high costs.

The present invention addresses the challenges of such remote and demanding needs with a self-contained, non-intrusive, and reliable monitor, that will furnish real time notification of operation stoppage. The alarm circumstance can be received where and how it is needed within minutes of a piece of equipment breaking down or ceasing to operate.

### SUMMARY OF THE INVENTION

The present invention makes use of satellite communication links to transmit predefined messages indicating conditions or status changes from the monitored location. The status of interest is the operation and the alarm condition occurs when a piece of equipment stops.

The equipment makes use of a low power satellite modem which transmits data packets to a satellite from the field installation. At the field installation there is a sensing device—in the described embodiment it is a vibration detector. When the equipment is operating, the vibration sensor detects the vibration associated with its operation. When the equipment stops, the vibration sensor detects this change in status. After user-definable threshold conditions are met, in order to eliminate false alarms, the present unit communicates the alarm to the satellite which sends the alarm notice, via the satellite, to the down link ground station. The threshold criteria are a minimum time interval over which the vibration must not exist, such as 1 minute, and a user-adjustable vibration level, above which the target vibration is considered to exist and below which operation is considered to have ceased. At the ground station, the alarm is directed to a monitoring station and then is communicated to the person or computer that processes the alarm and generates the appropriate response, such as a repair call to the staff responsible for the remote site.

The installation does not need a power generator or other external power as the unit is battery operated and is designed to be highly efficient. The installation at the field location is non-technical and easily accomplished. Any adjustments are likewise straightforward and doable by general personnel. Once installed no further maintenance or adjustment is required for the expected battery life of 2 years. The communication link is established by the satellite modem. The harshness of the environment and related concerns are addressed by packaged components in a waterproof container. The unit does not need to be integrated, wired or in other ways intrude into the piece of equipment that is being monitored. Thus there is no risk of damaging or altering the equipment and its operation. It is operational upon being attached to the equipment by mere superficial connections, such as magnets to hold the monitoring unit to the monitored equipment.

### BRIEF DESCRIPTION OF THE DRAWINGS

FIG. 1 represents a schematic representation of the monitoring site with the claimed apparatus, sending a signal of an alarm event that, by this embodiment, is received and transferred to the customer.

FIG. 2 represents a block diagram of the vibration detection circuitry, using a piezo electric element to detect vibrations with amplification, filter, condition test, and signal components.

FIG. 3 represents a block diagram showing the self-contained components of the apparatus encased in a weather tight enclosure.

### DETAILED DESCRIPTION OF THE INVENTION

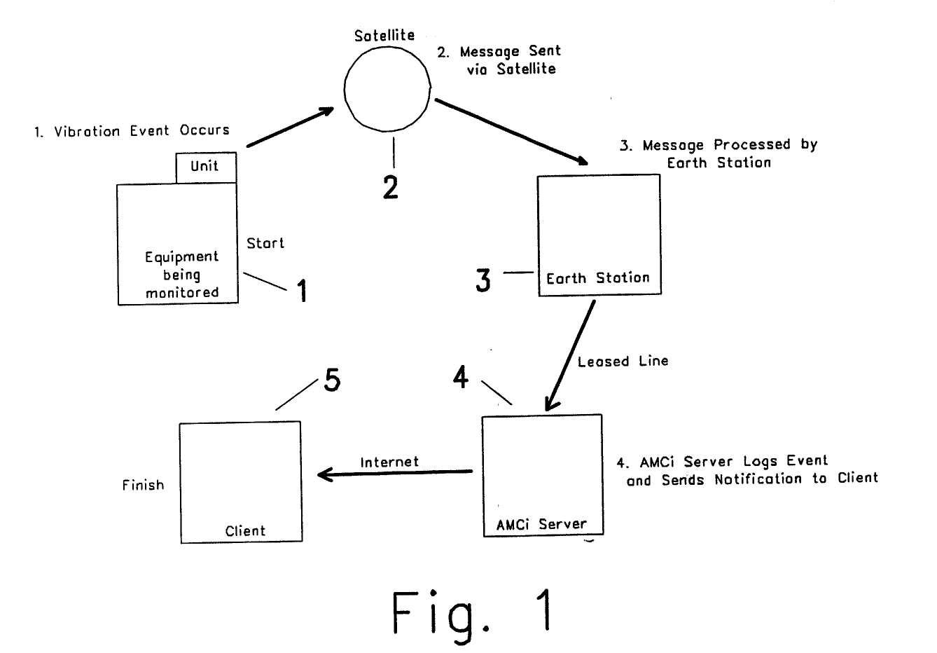

In FIG. 1 one signal path of an alarm event is depicted. The alarm event is defined to be when the target machine or equipment stops vibrating, such as when it stops working due to running out of gas or has a mechanical failure.

The unique apparatus of this invention is a self-contained signal generator (1) that communicates through a low power satellite modem that is compatible with satellite service in the geographic location of the remote equipment site. Transmission of the alarm to the satellite (2) and from there to a desired location for receipt can take many different paths. As depicted in FIG. 1, the signal is received at a downlink ground station (3) and transferred to a service location (4) and then made available over the worldwide web on a website used by the end customer (5). It also could trigger any other signal such as mail, a telephone call or pager notice.

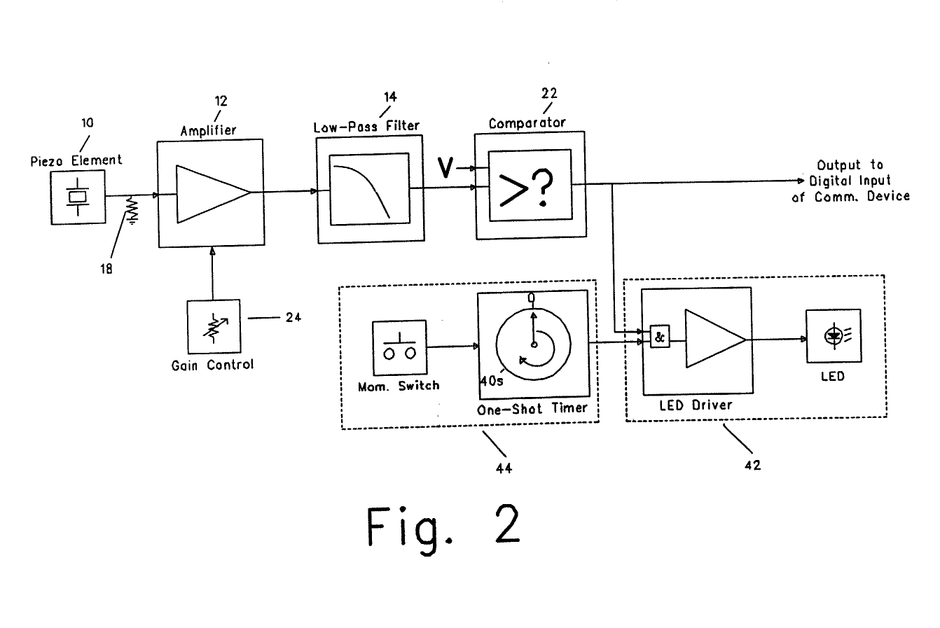

FIG. 2 is a block diagram of the vibration detection component. It illustrates the subcomponents to detect, amplify, filter and a method of minimizing false alarms of a status change in vibration or stoppage.

The detection of vibration is accomplished by a piezo electric element (10). As it vibrates and contorts, it internally creates an electrical signal. The degree of vibration varies the amount of the electrical signal. If the vibration stops, the electrical output ceases.

The particular piezo component chosen, the preferred embodiment, is a film element model LDTM-028K manufactured by Measurement Specialists. The configuration of this item is 13 mm×25 mm×205 μm. It is mounted on an edge extending outward from the circuit board. The electrical connectors are connected at the board. At the outboard end of the piezo component is a brad that creates a mass at this location. As vibration forces are inputted to the apparatus at the circuit board, the inertia of this mass causes the film to flex and thus distort causing electrical output.

In one embodiment of the invention, the circuit board is oriented in a vertical position, when the apparatus case is horizontal, with the top of the case facing upwards. The piezo, in its orthogonal position to the circuit board, is in turn oriented as a cantilever with the width dimension vertical. The piezo thus is susceptible to horizontal flexure by the vibration it sees.

In FIG. 2, the next block is a piezo amplifier (12) of any common design. As selected by the embodiment shown an IC Part No. LPV321M5 manufactured by National Semiconductor is used with an output of about 3 volts peak to peak.

This output is half-wave rectified and passed to a low pass filter (14) which clips the positive voltage peaks then to a capacitor to create variable DC voltages. This 2.2 micro-Farad capacitor is charged through a 10 kilo-ohm resistor and discharged through a 1 meg-ohm resistor in order to create a varying DC voltage that is representative of the amount of vibration being sensed at the piezo electric sensor. This minimizes spikes and averages the transient signals.

From this low pass filter the signal goes to a comparator (22) of common design. The preferred product is model LCM72151M manufactured by National Semiconductor. It operates to compare the amplified and filtered output of the piezo unit to a reference voltage. If the output voltage of the low pass filter is greater than the reference the comparator is in a non-alarm condition, or “0”. If the output voltage of the low pass filter to the comparator drops below the reference, the comparator goes to a status change and signals an alarm or a “1” status.

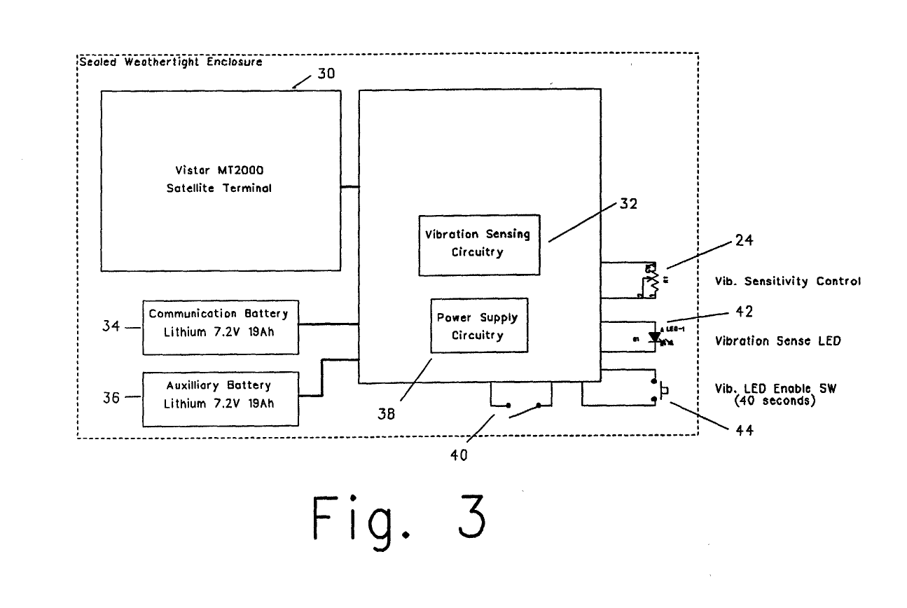

This binary status of the comparator is used to signal if there is or is not vibration, “1” being no vibration and “0” being vibration. The Vistar Model MT2000 (30) illustrated in FIG. 3 takes a reading of the comparator status once every second, using one of its digital inputs. By selecting the option on the Vistar (30) we require 60 successive matching readings of the comparator to confirm a status change and sending a signal of the alarm event. Thus if it were vibrating and the output of the low pass filter was greater than the reference voltage, and thus in a zero state, the Vistar would not send an alarm. If it stopped vibrating and the voltage dropped below the reference for less than 60 successive samples before starting to vibrate there would not be an alarm sent. Only if the 60 seconds or 60 consecutive samples of status “1”, are detected is the alarm signal created and sent.

Within FIG. 2 is a block representing the gain control (24) for the amplifier. For some installations the amplitude of the vibration can be very low or very high. In these circumstances, or if there is only one source of vibration, the output signal from the piezo film may need to be amplified more or less in order to get improved accuracy. To accomplish the simple field gain adjustment on the amp (12), a potentiometer is wired into the amp circuit. By adjusting the potentiometer the gain is controlled.

This adjustment then allows the gain to be reduced or increased in those circumstances where it is necessary to filter out other possible vibration sources, such as wind or other machinery that may be close by. This is readily accomplished at the field location.

FIG. 3 depicts the overall apparatus in a block diagram. The vibration sensor (10), amplifier (12) and filtering system (14), and comparator (22) of FIG. 2 are depicted in FIG. 3 as the vibration detection circuitry (32) and the sensitivity adjustment potentiometer or gain control (24). The remaining components include the communication (34) and auxiliary batteries (36), a common power supply circuitry (38) with an on/off switch (40), an LED circuitry and LED (42) to give a visible signal of the vibration sensor in state “0” and signal circuits for easy testing purposes, a test circuit (44), and a satellite modem (30)—a Vistar model MT2000 has the antennas, circuitry for message transmission, and the time discrimination capability to make sure there is a loss of vibration for 60 seconds or more before the event alarm is sent. In some embodiments an alternate Vistar or comparable satellite modem may be used with remote antennas to allow for installations where the machine to be monitored does not have a line of sight location to the satellite.

The Vistar model MT2000 (30) has time based filtering capability built into it. It is programmable to impose the time filter, in our case a 60 second time based filter threshold before the alarm event signal is sent to the satellite. Any time threshold may be used.

The setup of the device is easily accomplished. The first step is to insure the satellite communication link. This can be done at any location, in the field or not. Once the communication link has been confirmed the unit is ready for installation at the field site.

In positioning the unit, the case is oriented in a horizontal orientation. If other orientations are necessary, they can be accomplished by reconfiguring the piezo film so that its vertical cantilever position is maintained provided this position also permits the satellite modem's antennas to “see” the communication satellite.

Once mounted, the power is turned on. With the monitored equipment running, the potentiometer is adjusted so that a constant “0” state is present in the comparator circuit, i.e., showing that the gain is sufficient to make sure the amplified output of the piezo film exceeds the reference voltage of the comparator. A test button allows the LED to be on and to show that the vibration detector is working. In this embodiment it has a timing circuit to stay on for 40 seconds.

To insure that the signals are correct, the monitored equipment is turned off, or the case is removed from the equipment and its vibration. If the LED goes out the vibration sensor is in a “1” state. The LED can be checked by tapping the box to see if the LED comes back on. All of this occurs during a 20 second time window for test.

In circumstances where there are alternate sources of vibration, the gain may be turned down so as to limit the vibration sensor to be triggered only by the vibration from the targeted equipment, presumably the vibration with the greatest influence on the apparatus mounted on it.

In FIG. 2, the vibration circuit, a resistor (18) is chosen to complement and maximize the energy output of the piezo film. 10 meg ohms is selected as it gives the best results.

The IC of the piezo amplifier (12) is LPV3Z1M5 by National Semiconductor. It is a common amplifier design and amplifies the output to approximately 3.3 volts peak to peak.

The next stage a low pass filter (14) is a capacitor and 1 meg and 10 K ohm resistors to average the positive peaks of voltage and yield an output of variable DC voltage. The 10K resistor is in series with the capacitor and 1 meg resistor in parallel to ground. The resistor 1 meg ohm is selected to give a relatively long bleed off time for the capacitor. This is to average the output and minimize spiking of voltage and any abrupt low voltages which could trigger the comparator component to switch states unnecessarily. An alternate design is a differentiator to detect abrupt changes in voltage which would be shielded from the comparator.

The comparator (22) is an IC from National Semiconductor, part # LMC72151M. It compares the average voltage output to the reference voltage. If the output is greater than the constant, the comparator signals a “0” state indicating that the voltage output of the piezo film, as amplified, indicates that there is vibration. When the output voltage drops below the constant, the comparator goes to a state “1” indicating that there is no or insufficient vibration.

The design of the apparatus meets three basic parameters. First that the apparatus be self-contained, with high application survivability and minimal maintenance and installation needs or complexity. Second minimal power usage to conserve the batteries and to prolong life between maintenance, and thus to allow for self-contained independent operation. Third: a discriminatory sensor with simple field adjustments accomplished by personnel without training for a wide spectrum of vibration amounts and environments.

The packaging of the components requires no wiring or attachment to the equipment being monitored. It is attached by magnets or other suitable means. The case is weather tight with minimal openings i.e., only on/off switch, adjustment and test button. Inside the case the components, other than the LED, on/off switch, adjustment knob and test button are held inside the case by closed cell non-static electricity generating foam, such as 1.7 #Poly LAM. Other suitable materials may be used. This gives mechanical shock protection to the working components and thus makes the unit rugged. It also minimized fatigue failure to suspend the circuit board from the case that is being vibrated, while allowing the piezo vibration sensor to work. As described above the installation and calibration is accomplished easily without tools by the placement of the unit within line of sight of the satellite and testing the vibration signal to make sure it discriminates the target vibration, adjusting the gain so as to discern the subject machine and checking if the LED is on with vibration and then goes out when the unit is not vibrating.

The power usage is minimized by the selected components. The primary selection is of a low power satellite modem (30). It could be spread spectrum, or one way signal capable, or as in the preferred embodiment the low power modem is the Vistar MT2000 which works over a synchronous satellite network, so that it minimized the amount of time the satellite modem's RF circuitry is active, contributing significantly to increased battery life by signals if the satellite is not available. In other embodiments there may be other avenues to insure that a signal when sent is readily received, while maintaining a power conservative system.

The choice of the piezo electric film (10) for the vibration sensing element is based in its ability to be self-excited, requiring no external power to enable the element to produce a detectable output. This saves power and battery resources. The resistor (18) is selected to passively maximize the energy output of the piezo film and thus minimize the need for more amplification.

The amplifier (12) is selected to boost the output up to 3.3 volts, peak to peak, with minimal power consumption, i.e., 10-20 micro amps. The potentiometer (24) adjusts the gain in an energy efficient way. An alternative design choice to this could be to adjust the reference voltage to the comparator circuit and use a fixed gain piezo sensor amplifier, but this method loses fine tune capabilities at some ends of the spectrum. The potentiometer yields the widest range of fine tuning to thus accommodate the widest range of field situations, and enable simple field installation.

The low pass filter (14) element smoothes and averages the amp output so as to minimize transient vibration conditions or triggers of alarm status in the comparator and thus to minimize the energy used for state changes in the comparator. Alternate designs may use solid state differentiators to detect quick changes in voltage associated with vibration change events. Thus if a sudden change occurs it more than likely is a transient. The preferred embodiment is simple, relatively cheap and rugged.

The comparator (22) is very energy efficient, especially in the idle condition consuming only 1 micro amp of quiescent current. Thus by the filtering of transients, the comparator does not use more than the minimum except during transitions due to true alarm events. The use of the LED (42) is both energy conserving and help in visual recognition. In some field location audible signals would not be observable. The LED usage is also minimized by the timed operation. It is off except for the time window allowed by the timer circuitry of the timed test circuit (44) activated by the test button. Then it automatically turns off and uses no power.

The simple field adjustments are accomplished by the test LED (42) and (44) and the potentiometer (24) to adjust the gain, which field adjusts the vibration sensitivity.

I claim:

1. A remote vibration sensing apparatus comprising:
a) a satellite modem;
b) a vibration detector;
c) a means to compare the detector output value to a reference value,
d) a means to generate an alarm signal;
e) a means to communicate an alarm event signal to the satellite modem; and
f) the satellite modem communicates the alarm event signal to the satellite.

2. The apparatus of claim 1 wherein the satellite modem is a low power modem.

3. The apparatus of claim 1 wherein the vibration detector is a piezo electric component.

4. The apparatus of claim 3 wherein the piezo electric component is in a film form with a mass element to increase sensitivity.

5. The apparatus of claim 3 with a load resistor to increase the output of the piezo component.

6. The apparatus of claim 1 with an amplifier to amplify the output of the vibration detector.

7. The apparatus of claim 6 wherein the amplifier is a piezo amplifier.

8. The apparatus of claim 7 where the amplifier has a gain control to adjust the gain.

9. The apparatus of claim 8 where the gain control is a potentiometer.

10. The apparatus of claim 1 where there is a low pass filter after the amplifier.

11. The apparatus of claim 1 where the comparator creates a binary output signal.

12. The apparatus of claim 11 where the output signal goes to the satellite modem.

13. The apparatus of claim 11 where the output signal goes to a local signal means.

14. The apparatus of claim 13 where the signal means is an LED.

15. The apparatus of claim 14 where the LED is only able to be energized during a selected time.

16. The apparatus of claim 1 where the signal of an alarm event is only sent after a time condition is met.

17. The apparatus of claim 1 where the power is supplied by a battery.

18. The apparatus of claim 1 where the apparatus is removably attached to a piece of equipment.

19. The apparatus of claim 1 where the unit is suspended inside the case with resilient material.
